(19) United States
(12) Patent Application Publication
(10) Pub. No.: US 2019/0039200 A1
(43) Pub. Date: Feb. 7, 2019

(54) Air File

(71) Applicant: Jian-Shiou Liaw, Taichung City (TW)

(72) Inventor: Jian-Shiou Liaw, Taichung City (TW)

(21) Appl. No.: 15/665,505

(22) Filed: Aug. 1, 2017

(51) Int. Cl. B24B 23/02; B25D 9/08; B23D 51/18

(52) U.S. Cl. CPC B24B 23/026; B24B 23/00; B23D 51/18; B25D 9/08

(57) ABSTRACT

An air file has a body, a fastening member, and a driving assembly. The body has a handle and a front cover connected to the handle. The fastening member is swingably assembled to the front cover and has a pivoting end and a connecting end. The pivoting end of the fastening member is inserted inside the front cover. The connecting end of the fastening member extends out of the front cover. The driving assembly is mounted inside the body and has an eccentric shaft and a swinging unit. The eccentric shaft is connected to a driving device and has an eccentric hole facing to the front cover. The swinging unit has a pivoting portion and a ball joint. The pivoting portion is pivotally connected to the pivoting end of the fastening member. The ball joint is engaged in the eccentric hole of the eccentric shaft.

### BACKGROUND OF THE INVENTION

### 1. Field of the Invention

The present invention relates to a hand tool, and more particularly to an air file that has a simple structure and the advantage of energy conservation.

### 2. Description of Related Art

A file is a hand tool for polishing or grinding a workpiece with uneven surfaces or edges. A conventional reciprocating file has a motor, an eccentric component, a helical gear, a reciprocating shaft, and a tool holder. The motor has a driving shaft. The eccentric component has a first shaft and a second shaft. The first shaft and the second shaft of the eccentric component are eccentric and extend toward two opposite directions. The helical gear is mounted on and around the first shaft of the eccentric component and contacts a front end of the driving shaft of the motor. The helical gear is driven by the front end of the driving shaft of the motor. The helical gear and the first shaft are able to rotate simultaneously. The reciprocating shaft has two opposite ends. One of the two opposite ends of the reciprocating shaft is mounted on and around the second shaft of the eccentric component. The tool holder is connected to the other opposite end of the reciprocating shaft. The tool holder is utilized for assembling a file blade.

The motor drives the helical gear to rotate. The first shaft of the eccentric component and the helical gear rotate simultaneously. The second shaft of the eccentric component drives the reciprocating shaft to move backwards and forwards. The reciprocating shaft drives the tool holder with the file blade to grind or polish a workpiece.

However, the conventional reciprocating file has complex structures. The power supplied by the motor is transferred from the helical gear, the first shaft and the second shaft of the eccentric component, and then to the reciprocating shaft. The power supplied by the motor is consumed gradually during the transmission and causes a problem of energy waste.

To overcome the shortcomings of the conventional reciprocating file, the present invention provides an air file to mitigate or obviate the aforementioned problems.

### SUMMARY OF THE INVENTION

The main objective of the present invention is to provide an air file with a simple structure and may reduce energy consumption.

The air file comprises a body, a fastening member, and a driving assembly. The body has a handle and a front cover connected to the handle. The fastening member is swingably assembled to the front cover and has a pivoting end and a connecting end. The pivoting end of the fastening member is inserted inside the front cover. The connecting end of the fastening member extends out of the front cover. The driving assembly is mounted inside the body and has an eccentric shaft and a swinging unit. The eccentric shaft is connected to a driving device and has an eccentric hole facing to the front cover. The swinging unit has a pivoting portion and a ball joint. The pivoting portion is pivotally connected to the pivoting end of the fastening member. The ball joint is engaged in the eccentric hole of the eccentric shaft.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an air file in accordance with the present invention;

FIG. 2 is a partially exploded perspective view of the air file in FIG. 1;

FIG. 3 is a see-through perspective view in partial section of the air file in FIG. 1;

FIG. 4 is a side view in partial section of the air file in FIG. 1;

FIG. 5 is a top view in partial section of the air file in FIG. 1; and

FIG. 6 is an operational top view in partial section of the air file in FIG. 1.

### DETAILED DESCRIPTION OF PREFERRED EMBODIMENT

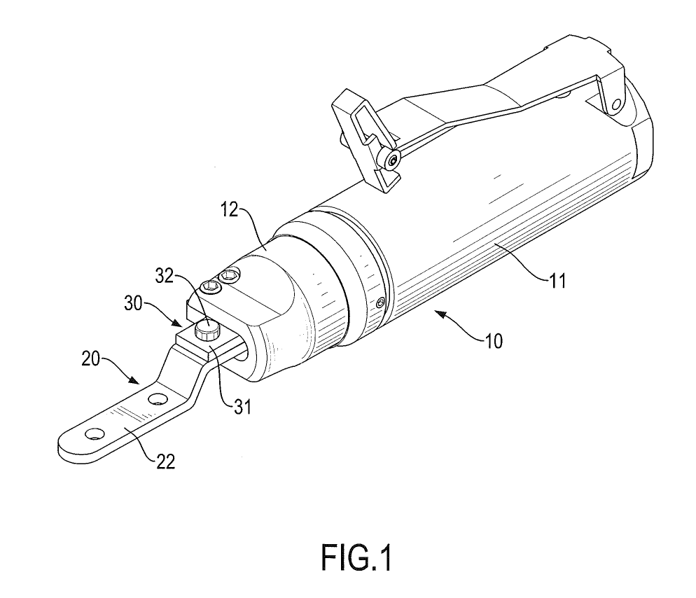

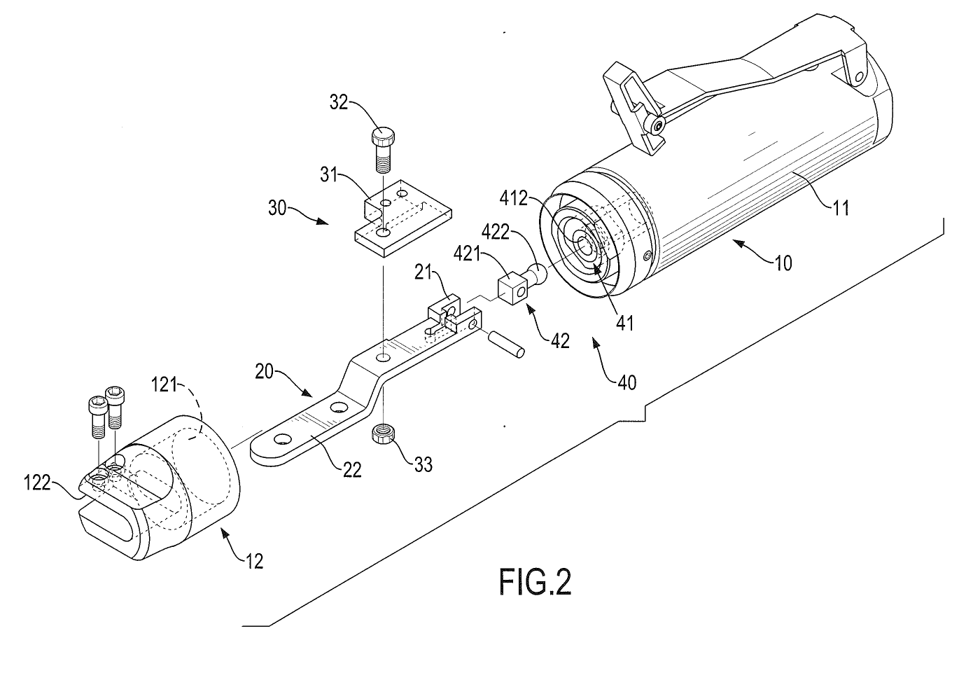

With reference to FIGS. 1 and 2, an air file in accordance with the present invention comprises a body 10, a fastening member 20, a pivoting assembly 30, and a driving assembly 40. The fastening member 20, the pivoting assembly 30, and the driving assembly 40 are assembled on the body 10.

With reference to FIGS. 1 and 2, the body 10 has a handle 11 and a front cover 12. The handle 11 is hollow, and a driving device 50 is mounted inside the handle 11. The driving device 50 may be an electric motor or a pneumatic rotor. The front cover 12 has a first end, a second end, a receiving hole 121, and a receiving recess 122. The first end and the second end of the front cover 12 are opposite each other. The receiving hole 121 extends from the first end of the front cover 12 toward the second end of the front cover 12. The receiving recess 122 has a cross-section in an elongated shape. The receiving recess 122 extends from the second end of the front cover 12 toward the first end of the front cover 12. The receiving recess 122 communicates with the receiving hole 121. The first end of the front cover 12 is connected to the handle 11. The receiving hole 121 communicates with an interior of the handle 11.

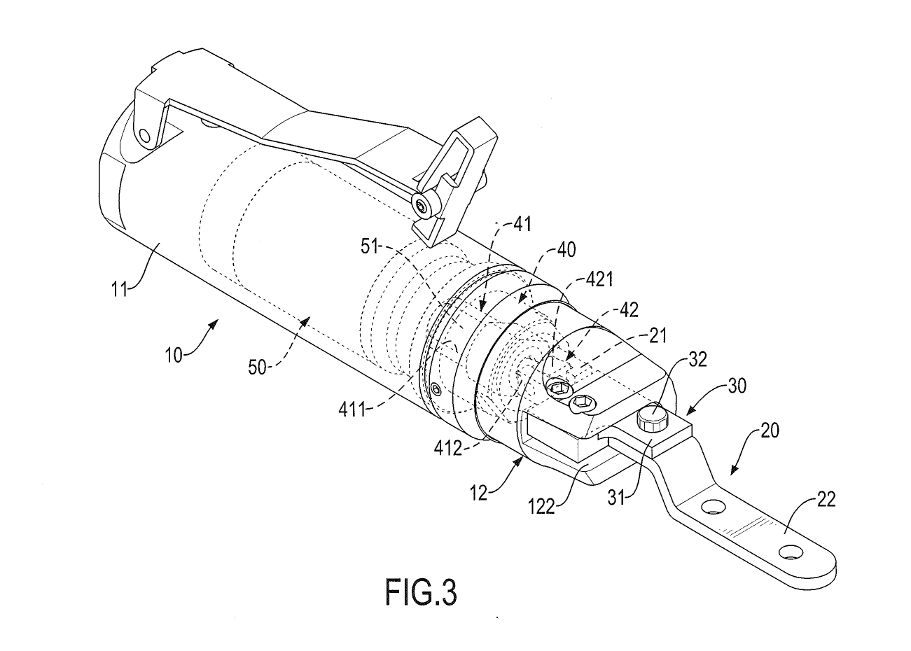

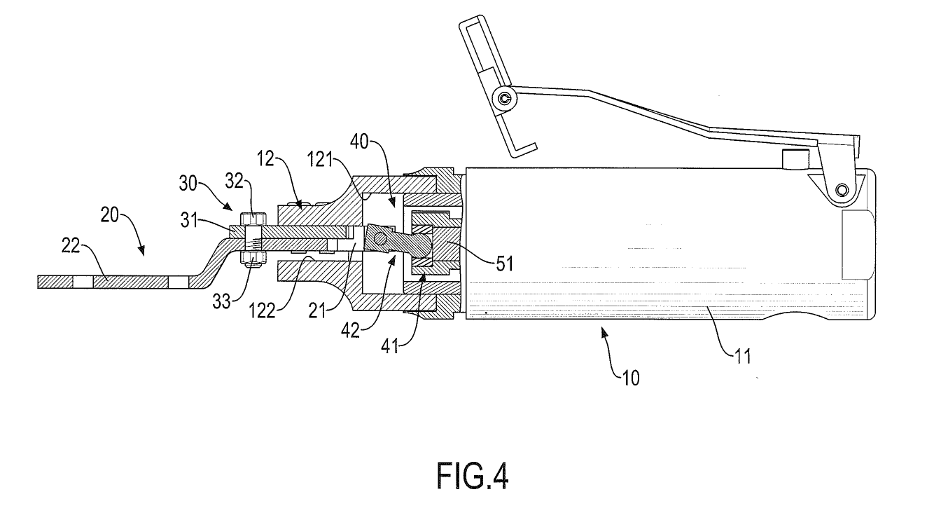

With reference to FIGS. 2, 3, and 4, the fastening member 20 is swingably assembled to the front cover 12 of the body 10. The fastening member 20 has a pivoting end 21 and a connecting end 22. The pivoting end 21 of the fastening member 20 is inserted inside the front cover 12 and extends to the receiving hole 121 of the front cover 12. The connecting end 22 of the fastening member 20 passes through the receiving recess 122 of the front cover 12 and extends out of the front cover 12. The connecting end 22 of the fastening member 20 is utilized to fix tools such as file blades or sharpening stone.

With reference to FIGS. 2, 3, and 4, the pivoting assembly 30 has a pivoting board 31, a pivoting bolt 32, and a nut 33. The pivoting board 31 is inserted in the receiving recess 122 of the front cover 12 and is screwed with the front cover 12 by two bolts. The pivoting bolt 32 passes through the pivoting board 31 and the fastening member 20. The nut 33 is screwed with the pivoting bolt 32. The nut 32 and the pivoting bolt 31 clamp the pivoting board 31 and the fastening member 20 together. The fastening member 20 is pivotally connected to the pivoting board 31, and the fastening member 20 is swingably assembled to the front cover 12 by the pivoting board 31.

With reference to FIGS. 2, 3, and 4, the driving assembly 40 has an eccentric shaft 41 and a swinging unit 42. The eccentric shaft 41 is connected to the driving device 50. The eccentric shaft 41 has a first end, a second end, an axial hole 411, and an eccentric hole 412. The axial hole 411 extends from the first end of the eccentric shaft 41 toward the second end of the eccentric shaft 41. In the embodiment of the present invention, the driving device 50 is a pneumatic mechanism with a driving shaft 51. The axial hole 411 of the eccentric shaft 41 is disposed around the driving shaft 51 of the pneumatic rotor. The eccentric hole 412 extends from the second end of the eccentric shaft 41 toward the first end of the eccentric shaft 41, and communicates with the axial hole 411.

The driving assembly 40 is mounted inside the body 10, and the eccentric hole 412 of the eccentric shaft 41 faces to the front cover 12 of the body 10. The swinging unit 42 has a pivoting portion 421 and a ball joint 422. The pivoting portion 421 and the ball joint 422 are opposite each other. The pivoting portion 421 is pivotally connected to the pivoting end 21 of the fastening member 20. The ball joint 422 is engaged in the eccentric hole 412 of the eccentric shaft 41.

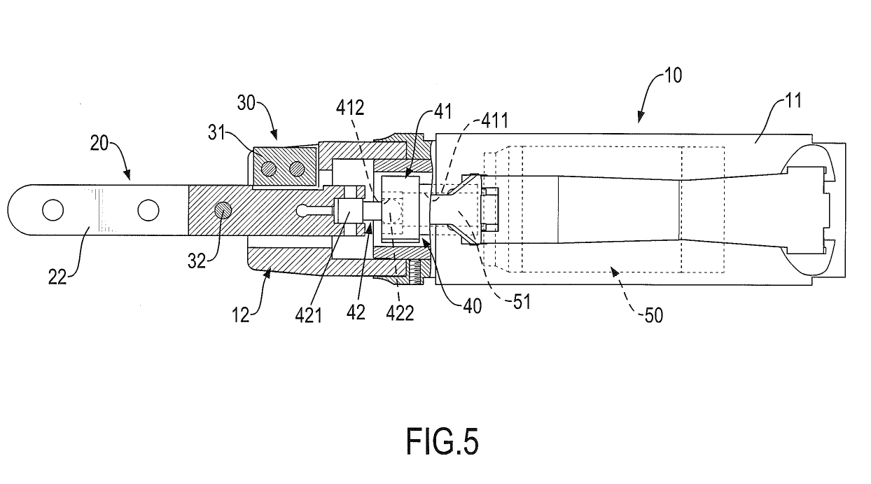

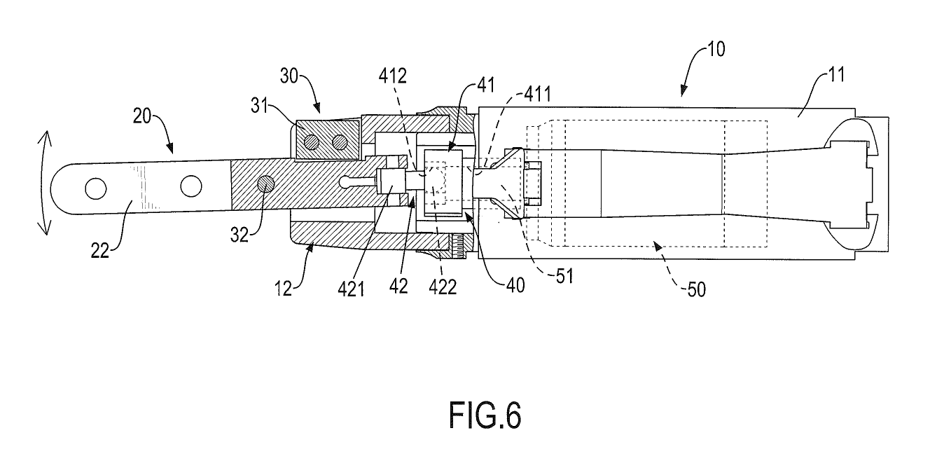

With reference to FIGS. 5 and 6, in use, the driving device 50 operates, and the driving shaft 51 of the driving device 50 drives the eccentric shaft 41 of the driving assembly 40 to rotate. The ball joint 422 of the swinging unit 42 is engaged in the eccentric hole 412 of the eccentric shaft 41 and makes the swinging unit 42 swing relative to the eccentric shaft 41. Since the pivoting portion 421 of the swinging unit 42 is pivotally connected to the fastening member 20, the swinging unit 42 may drive the fastening member 20 that is pivotally connected to the pivoting board 31 to swing relative to the front cover 12 of the body 10. The air file in accordance with the present invention alters the linear operating manner of the conventional reciprocating file into a swinging manner and omits some components such as a helical gear to accomplish a simpler structure. Compared to the conventional reciprocating file with the linear operating manner, the air file in accordance with the present invention avoids energy consumption during power transfer between components and thus saves energy.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An air file comprising:
a body having
a handle; and
a front cover connected to the handle;
a fastening member swingably assembled to the front cover and having
a pivoting end inserted inside the front cover; and
a connecting end extending out of the front cover;
a driving assembly mounted inside the body and having
an eccentric shaft connected to a driving device and having an eccentric hole facing to the front cover; and
a swinging unit having
a pivoting portion pivotally connected to the pivoting end of the fastening member; and
a ball joint engaged in the eccentric hole.

2. The air file as claimed in claim 1 further having a pivoting assembly, wherein
the pivoting assembly has a pivoting board fixed to the front cover; and
the fastening member is pivotally connected to the pivoting board and is swingably assembled to the front cover by the pivoting board.

3. The air file as claimed in claim 2, wherein the pivoting assembly has
a pivoting bolt passing through the pivoting board and the fastening member; and
a nut screwed with the pivoting bolt.

4. The air file as claimed in claim 3, wherein
the driving device is a pneumatic mechanism with a driving shaft;
the eccentric shaft has an axial hole having an axis deviating from an axis of the eccentric hole; and
the axial hole is disposed around the driving shaft.

5. The air file as claimed in claim 4, wherein
the front cover has
a receiving hole connecting to an interior of the handle; and
a receiving recess connecting to the receiving hole;
the pivoting end of the fastening member extends to the receiving hole; and
the connecting end of the fastening member passes through the receiving recess and out of the front cover.

6. The air file as claimed in claim 1, wherein
the driving device is a pneumatic mechanism with a driving shaft;
the eccentric shaft has an axial hole having an axis deviating from an axis of the eccentric hole; and
the axial hole is disposed around the driving shaft.

7. The air file as claimed in claim 1, wherein
the front cover has
a receiving hole connecting to an interior of the handle; and
a receiving recess connecting to the receiving hole;
the pivoting end of the fastening member extends to the receiving hole; and
the connecting end of the fastening member passes through the receiving recess and out of the front cover.
